(19) United States
(12) Patent Application Publication
(10) Pub. No.: US 2023/0070213 A1
(43) Pub. Date: Mar. 9, 2023

(54) METHOD FOR MANUFACTURING HIGH-FREQUENCY FUNCTIONAL STRUCTURES

(71) Applicant: FRIEDRICH-ALEXANDER-UNIVERSITÄT ERLANGENNÜRNBERG, Erlangen (DE)

(72) Inventors: Gerald Gold, Erlangen (DE); Klaus Helmreich, Altdorf (DE); Konstantin Lomakin, Nürnberg (DE); Mark Sippel, Fürth (DE)

(21) Appl. No.: 17/800,130

(22) PCT Filed: Feb. 15, 2021
(86) PCT No.: PCT/EP2021/053642

§ 371 Date: Aug. 16, 2022

(30) Foreign Application Priority Data
Feb. 17, 2020 (DE) 10 2020 104 038.5

(51) Int. Cl. H01P 11/00; B05D 1/18; B05D 1/02; B05D 1/26; B05D 3/02; B05D 3/06; C09D 5/24

(52) U.S. Cl. CPC H01P 11/001; B05D 1/02; B05D 1/18; B05D 1/26; B05D 3/065; B05D 3/0254; C09D 5/24

(57) ABSTRACT

The invention relates to a method of manufacturing technical radio frequency functional structures comprising the steps of providing a base body determining the shape of the functional structure and applying an electrically conductive layer to the shape-determining base body by means of wetting the base body with a dispersion containing microparticles and/or nanoparticles.

The present invention relates to a method of manufacturing. Radio frequency functional structures.

Such a functional structure is, for example, a waveguide for guiding electromagnetic waves. Electromagnetic waves, in particular radio frequency signals, can propagate either in a space or in waveguide devices. Such waveguide devices provide conductive structures that comprise a spatial area and thus form a spatial path or channel to conduct the electromagnetic waves or radio frequency signals therein or to manipulate them in space or in the frequency range.

On the manufacture of radio frequency components, the component is composed of two halves due to production reasons, in particular to generate hollow spaces. The hollow spaces thus produced, e.g. milled in a metallic base body, produce the actual functionality of the radio frequency assembly. They can e.g. be waveguides, so-called RF waveguides, but also filters, resonators, couplers, or antennas.

Such radio frequency components can also be produced from 3D printed or injection molded plastic base bodies. They have to be provided with a conductive coating for the later function. Galvanic or electroless coating with metals is the prior art.

The electric conductivity and the property of the component surface that interacts with the electromagnetic wave are essential; an inner wall forming the hollow space in particular has to be electrically conductive. The manufacture of the components from metal or from an electrically conductive base material is not only cost-intensive, but also complex; it in particular makes cost-intensive CNC milling processes necessary. Against this background, the approach has already been pursued in the prior art of instead producing such components from plastic and only to make them conductive in a step interposed downstream. Known process proposals provide chemical processes here such as a galvanic or also electroless coating of the base body surface with metals.

Due to the process, the galvanizing of hollow spaces is difficult or only possible using electrodes that have been introduced into the corresponding hollow spaces and represents a restriction for the shaping of the radio frequency components caused by the production. Care only has to be taken for an electroless coating that the process liquids reach the corresponding surfaces, which can be achieved without problem with radio frequency components, e.g. waveguides, in that conductive structures are only installed about spatial areas to the extent as and where they are required for the technical radio frequency function. The electroless coating therefore restricts the degrees of freedom in the design of radio frequency components less than the galvanic coating.

With respect to the previously known processes, there is a desire for a further simplification of the coating process to in particular also enable a more complex shaping of the components and to additionally improve physical properties of the surface structure such as the adhesive strength or surface roughness.

This object is achieved by the method in accordance with the invention in accordance with the features of claim 1. Advantageous embodiments of the method are the subject of the dependent claims.

It is proposed in accordance with the invention to first provide a base body determining the shape of the functional structure in the manufacture of a functional structure for technical radio frequency components. The material for the production of the base body is preferably not electrically conductive; however, an electrically conductive or semi-conductive material could equally be used for the manufacture of the base body.

The required electrically conductive coating of the base body is achieved in accordance with the invention in that at least some, preferably all of the surface of the base body is wetted with an electrically conductive dispersion containing microparticles and/or nanoparticles. The dispersion can be an ink having microparticles or nanoparticles. The (ink) materials used are preferably those that achieve high conductivities. The dispersion or the ink is preferably water-based; an organic separating agent can additionally be provided. Alternatively or additionally, a solvent can be admixed. Conceivable nanoparticles are particles of aluminum, silver, gold or copper or a mixture thereof. The dispersion or the tint is here calibrated to the surface energy of the basic body material, for example plastic, used so that a sufficient wetting of the surface is promoted. The viscosity of the dispersion or of the ink material can furthermore be calibrated to the smallest apertures that are present in the base body structure so that the wetting by the dispersion is ensured.

After the evaporation/vaporization of the solvent/water, the surface of the base body is wetted with the ink material and a conductive coating is formed by an optional post-treatment, preferably sintering. The new process thus presents an alternative to a chemical, electroless coating. The base material body is thereby functionalized, i.e. becomes the radio frequency component in that it is fully or partially coated with conductive ink material.

Unlike chemical coating processes in which a body is introduced into a reagent liquid and a chemical reaction occurs between the reagent liquid and the surface of the body, the present process instead focuses on a dispersion for the coating that wets the base body physically and forms a conductive coating by a post-treatment.

With respect to the chemical coating process, a smoother surface structure of the coated base body can be achieved by the method in accordance with the invention, which in particular brings about decisive advantages in components of radio frequency technology. The smoother the surface of the component, the better the later conductivity of the component in the radio frequency application. The chemical process of existing methods frequently results in a disadvantageous coarsening of the body’s surface due to a required pre-treatment.

The method in accordance with the invention can, for example, be advantageously used in the manufacture of RF lines, antennas, for example horn antennas or helix antennas, and of waveguides, filters, resonators, couplers, or other passive RF components, with the functionality of these components being formed by the coated base body. Some of these functional structures require a spatial area surrounded by conductive structures for conducting the electromagnetic waves. In this case, the base body is designed with corresponding structures at the points required for the technical radio frequency function, where it is required for the mechanical or electrical function or where it only restricts them a little.

The application and wetting preferably takes place by a complete immersion of the base body in a dipping bath that contains the corresponding dispersion. The single-time immersion of the base body is sufficient in principle. A better distribution of the dispersion about or through the base body, in particular in a hollow space that is optionally present, is ensured by multiple immersions. An ultrasound bath containing the dispersion is preferably used. After the immersion into the dipping bath, the base body can be briefly shaken to remote excess dispersion.

As an alternative to the dipping bath, the dispersion can also be applied by means of an aerosol chamber in which the dispersion nebulized into droplets wets the base body. There is furthermore the possibility of also coating or wetting the base body by spraying it with the dispersion or pouring it over it.

After the dispersion has been applied, the quality of the coating and its conductivity can be established or improved by thermal post-treatment of the base body surface or of the adhering microparticles or nanoparticles. A sintering in a furnace, a UV treatment, the supply of hot air, or infrared irradiation are possibilities for this. A thermal post-treatment can have a positive effect on the electrical conductivity of the applied coating. A high conductivity of the resulting surface coating is thus achieved by the subsequent sintering of the microparticles or nanoparticles, e.g. in a thermal furnace. The sintering temperature of the tint martial is calibrated to the glass transition temperature of the plastic used so that it is not damaged.

It can equally be advantageous if a surface pre-treatment of the base body is carried out before the application of the dispersion in order in particular to achieve a surface cleaning or a surface activation for an optimized adhesion of the coating.

It is decisive during the coating process, in particular on the introduction into a corresponding dipping bath, that the corresponding dispersion can reach all the inner wall surfaces to be coated. For the promoting of the liquid circulation, it can therefore likewise be advantageous to design the base body such than base body material is only present where it is required for the mechanical or electrical function or only restricts them a little, that is only to set up specific walls of the base body there from the start or to subsequently provide them with cutouts. The penetration of the dispersion into a hollow space is thereby simplified. The viscosity of the dispersion or of the ink material used can furthermore be calibrated to the smallest apertures that are present in the base body structure so that the circulation is ensured.

With rectangular hollow bodies or hollow spaces, walls corresponding to the side walls of a substrate integrated waveguide (SIW) known from the prior art can be designed as discontinuous since these apertures do not impair the technical radio frequency function, which is likewise known in the prior art. The narrow-side walls of the hollow space are slit, for example, while the broad-side walls of the rectangular hollow body can be designed without corresponding apertures.

As already explained above, the base body can consist of an electrically nonconductive material. Ceramics or plastic have proven to be particularly suitable here. The manufacture of the base body can then take place by means of an additive process, for example by means of SLA 3D printing. A manufacture by means of injection molding processes is equally conceivable.

In addition to the method in accordance with the invention, the invention also comprises a comprising functional structure for a component of the radio frequency technology that was manufactured by means of the method in accordance with the invention. The same advantages and properties accordingly result for the functional structure such as were already explained with reference to the method in accordance with the invention so that a repeat description will be dispensed with at this point.

Further advantages and properties of the invention will be presented in the following with reference to some examples for radio frequency components that were manufactured by means of the method in accordance with the invention. There are shown:

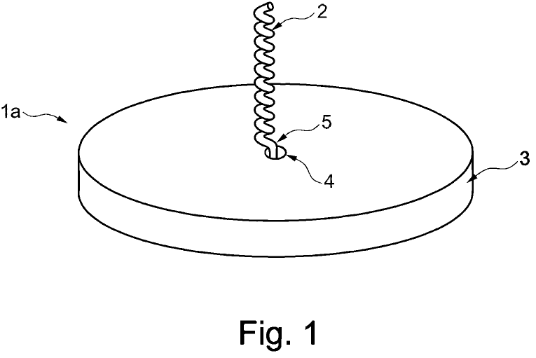

FIG. 1 a helix antenna manufactured by means of the method in accordance with the invention;

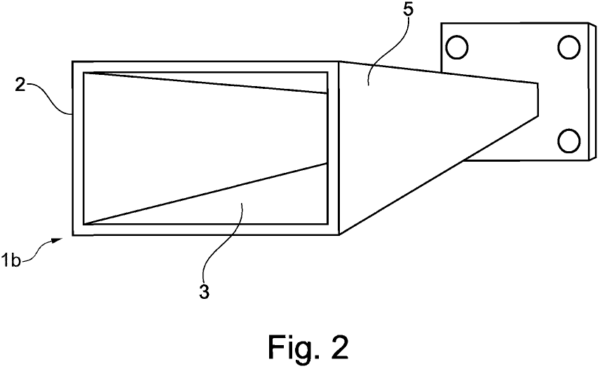

FIG. 2 a rectangular horn antenna manufactured by means of the method in accordance with the invention;

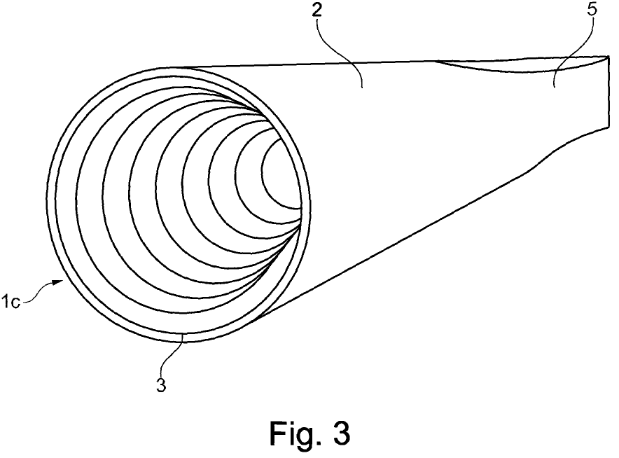

FIG. 3 a ridged horn antenna manufactured by means of the method in accordance with the invention;

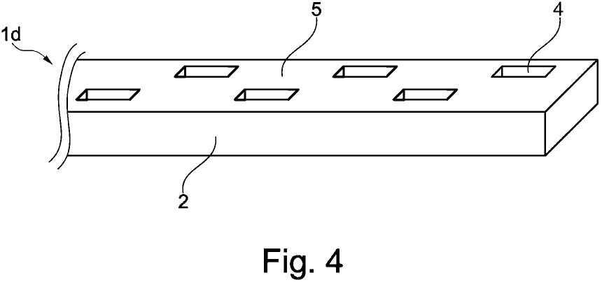

FIG. 4 a slotted waveguide antenna manufactured by means of the method in accordance with the invention;

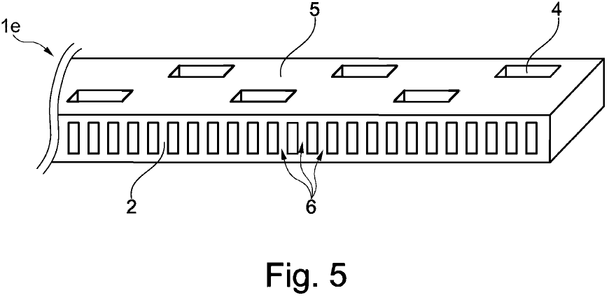

FIG. 5 a further slotted waveguide antenna manufactured by means of the method in accordance with the invention;

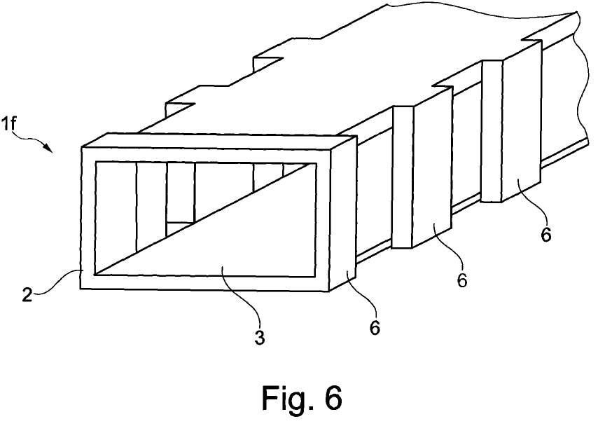

FIG. 6: a waveguide manufactured by means of the method in accordance with the invention,

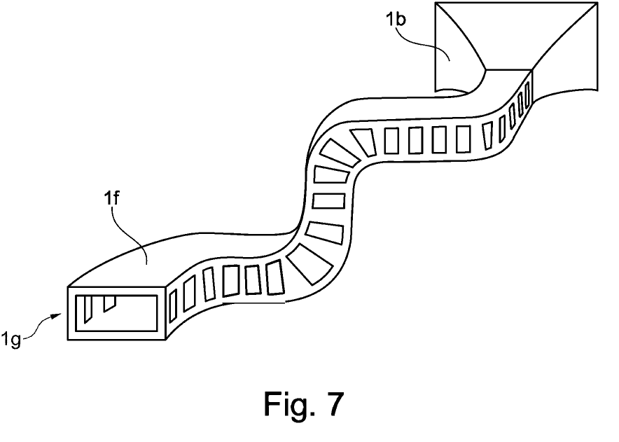

FIG. 7 a more complex system composed of radio frequency components manufactured by means of the method in accordance with the invention comprising waveguides, waveguide bends, and a horn antenna; and

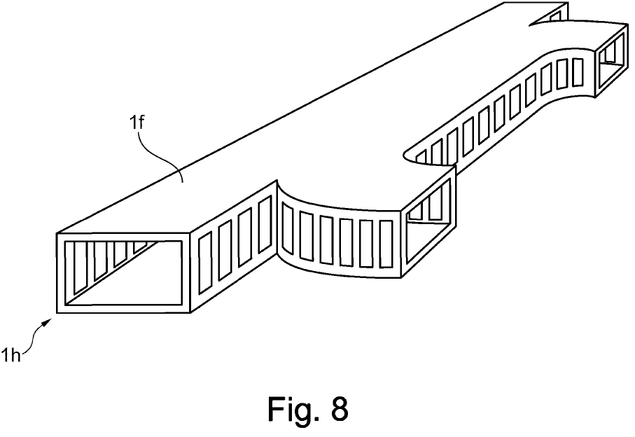

FIG. 8 a waveguide coupler manufactured by means of the method in accordance with the invention.

FIG. 1 shows a helix antenna 1a in accordance with the invention produced in accordance with the method in accordance with the invention. The helix antenna comprises a spiral helix 2 and a circular planar base surface 3 having a circular aperture 4 through which the lower end 5 of the helix is guided. The helix 2 and the base surface 3 are of a plastic base but in accordance with the invention an electrically conductive ink containing nanoparticles was applied to their surfaces. The helix 2 and the base surface 3 were first manufactured by means of an additive process such as SLA 3D printing for this purpose and were designed on the lower side of the base surface 3 as a radio frequency connector conforming to standards, for example as a waveguide flange.

FIG. 2 shows a horn antenna 1b that comprises a base body 2 and has a horn aperture with a rectangular cross-sectional portion. Inner walls 3 and outer walls 5 are coated as conductive in accordance with the method in accordance with the invention.

FIG. 3 shows a ridged horn antenna 1c as an example for a further passive radio frequency component. The component differs from the rectangular horn antenna 1b by a horn aperture having a round cross-sectional portion 2 and a transition 5 to a connection having a rectangular cross-section conforming to the standards. The inner wall of the horn aperture has a stepped or ridged surface 3. The manufacture of such a component can advantageously also be performed by means of the method in accordance with the invention.

FIG. 4 shows a slotted waveguide antenna 1d in accordance with the invention produced and coated as conductive in accordance with the method in accordance with the invention. The slotted waveguide antenna comprises a base body 2 having a rectangular cross-sectional portion on whose additive production apertures 4 remain in certain outer walls so that the intended function of the irradiation of an electromagnetic wave initially guided in the interior is achieved.

FIG. 5 in contrast shows a slotted waveguide antenna 1e in accordance with the invention, produced and coated as conductive in accordance with the method in accordance with the invention whose basic design is similar to that of the slotted waveguide antenna 1d, but with base body material only being built up where it is necessary (6) for the technical radio frequency function, which can likewise advantageously be performed by means of the method in accordance with the invention.

FIG. 6 shows a waveguide 1f for the radio frequency technology, produced in accordance with the method in accordance with the invention. The waveguide 1f substantially comprises a hollow body having a rectangular portion as the base body 2 whose inner walls 3 form the required hollow space for the guiding of electromagnetic waves. Base body material 6 is only built up in a similar manner to the slotted waveguide antenna 1e where it is required for the technical radio frequency function.

FIG. 7 shows a functional structure 1g that is designed in a similar manner to the waveguide 1f, but predefines a path bent in space for the electromagnetic waves. The one end is formed in accordance with a horn antenna 1b. The method in accordance with the invention for the electrically conductive coating of the functional structure is also used here.

FIG. 8 shows a coupler 1h for the radio frequency technology whose basic design is similar to two waveguides 1f contacting at their side walls. Apertures are functionally necessary between the two waveguides along these contact surfaces to enable an overcoupling of the electromagnetic waves from one waveguide into the other. All the other surrounding conductive structures are built up in a similar manner to the waveguide 1f where they are required for the guidance of the electromagnetic waves. The method in accordance with the invention for the electrically conductive coating of the surface of the coupler 1h is also used here.

1. A method of manufacturing technical radio frequency functional structures, the method comprising the steps:
providing a base body determining the shape of the functional structure;
applying an electrically conductive layer to the shape-determining base body by means of wetting the base body with a dispersion containing microparticles and/or nanoparticles.

2. A method in accordance with claim 1, characterized in that the step of coating comprises a single or multiple immersion of the base body into a dipping bath, in particular an ultrasound bath, containing the dispersion.

3. A method in accordance with claim 1, characterized in that the step of coating provides a treatment of the base body in an aerosol chamber to apply the dispersion to the base body.

4. A method in accordance with claim 1, characterized in that the step of coating takes place by pouring dispersion over the base body.

5. A method in accordance with claim 1, characterized in that the step of coating takes place by spraying the base body with the dispersion.

6. A method in accordance with one of the preceding claims, characterized in that the microparticles and/or nanoparticles are particles of gold and/or silver and/or copper and/or aluminum and/or particles of other substances that form conductive layers.

7. A method in accordance with one of the preceding claims, characterized in that, after the coating, a thermal post-treatment of the base body takes place, in particular by sintering, ultraviolet treatment, supply of hot air, or infrared irradiation.

8. A method in accordance with one of the preceding claims, characterized in that the functional structure is a radio frequency line, in particular a waveguide, or an antenna, in particular a horn antenna or helix antenna, or a filter, or a resonator, or a coupler, or any other passive RF part.

9. A method in accordance with one of the preceding claims, characterized in that the base body is designed such that base body material is only present where it is necessary for the mechanical strength and/or where a conductive surface is necessary to ensure the technical radio frequency function, in particular such that walls are provided with apertures or are fully or partially designed as helices or lattices.

10. A method in accordance with one of the preceding claims, characterized in that the dispersion has a water base and/or a base of one or more solvents and/or additional adhesives.

11. A method in accordance with one of the preceding claims, characterized in that the base material consists of or comprises ceramics or plastic or metal.

12. A method in accordance with one of the preceding claims, characterized in that the base body is manufactured by means of an additive process, in particular SLA 3D printing, or plastic injection molding.

13. A method in accordance with one of the preceding claims, characterized in that the surface of the base body is pre-treated before the coating.
